(19) United States
(12) Patent Application Publication
(10) Pub. No.: US 2024/0033753 A1
(43) Pub. Date: Feb. 1, 2024

(54) A CENTRIFUGAL SEPARATOR

(71) Applicant: Alfa Laval Corporate AB, LUND (SE)

(72) Inventors: Klas HILDING, ÄLTA (SE); Tomas DEURELL, ÅRSTA (SE)

(73) Assignee: Alfa Laval Corporate AB, LUND (SE)

(21) Appl. No.: 18/275,951

(22) PCT Filed: Feb. 2, 2022
(86) PCT No.: PCT/EP2022/052442

§ 371 Date: Aug. 4, 2023

(30) Foreign Application Priority Data
Feb. 17, 2021 (EP) 21157557.6

(51) Int. Cl. B04B 1/08; B04B 1/14; B04B 7/08

(52) U.S. Cl. CPC B04B 1/08; B04B 1/14; B04B 7/08

(57) ABSTRACT

A centrifugal separator for separating at least one liquid phase and a solids phase from a liquid feed mixture includes a frame, a drive member and a rotating part. The drive member is configured to rotate the rotating part in relation to the frame around an axis of rotation. The rotating part includes a centrifuge bowl enclosing a separation space and a sludge space. The separation space includes a stack of separation discs arranged coaxially around the axis of rotation and the sludge space is arranged radially outside said stack of separation discs. The centrifuge bowl includes an inlet for receiving the liquid feed mixture, at least one liquid outlet for a separated liquid phase, and at least one sludge outlet for a separated solids phase. The upper inner surface of the sludge space forms an upper sludge space angle β relative the axis of rotation as seen in an axial plane. The upper inner surface extends radially at least half the radial distance from the at least one sludge outlet to the radial outer edge of the stack of separation discs and the upper sludge space angle β is more than 5 degrees but less than 15 degrees.

### FIELD OF THE INVENTION

The present invention relates to the field of centrifugal separators, and more a centrifugal separator for separating at least one liquid phase and a solids phase from a liquid feed mixture.

### BACKGROUND OF THE INVENTION

Centrifugal separators are generally used for separation of liquids and/or for separation of solids from a liquid. During operation, liquid mixture to be separated is introduced into a rotating bowl and heavy particles or denser liquid, usually water, accumulates at the periphery of the rotating bowl whereas less dense liquid accumulates closer to the central axis of rotation. This allows for collection of the separated fractions, e.g. by means of different outlets arranged at the periphery and close to the rotational axis, respectively.

The separation capacity of a disc-stack centrifugal separator is e.g. depending on the rotational speed of the centrifuge bowl and the number and size of the separation discs that are fitted within the centrifuge bowl. However, increasing the size of the bowl is costly and also affects other parts and functions of the separator, such as energy consumption etc. The same is for the rotational speed, i.e. the material of the centrifuge bowl may have an upper rotational speed (limit speed) which should not be exceeded.

Thus, there is a need in the art for improved centrifugal separators in which the separation capacity is increased in a way that is easy to implement.

### SUMMARY OF THE INVENTION

It is an object of the invention to at least partly overcome one or more limitations of the prior art. In particular, it is an object to provide a centrifugal separator having increased capabilities of separating solids and at least one liquid phase from a liquid feed mixture.

As a first aspect of the invention, there is provided a centrifugal separator for separating at least one liquid phase and a solids phase from a liquid feed mixture, comprising
a frame, a drive member and a rotating part,
wherein the drive member is configured to rotate the rotating part in relation to the frame around an axis of rotation, and
wherein the rotating part comprises a centrifuge bowl enclosing a separation space and a sludge space;
wherein the separation space comprises a stack of separation discs arranged coaxially around the axis of rotation (X) and wherein said sludge space is arranged radially outside said stack of separation discs;
wherein the centrifuge bowl further comprises an inlet for receiving the liquid feed mixture, at least one liquid outlet for a separated liquid phase, and at least one sludge outlet for a separated solids phase arranged at the periphery of the centrifuge bowl;
wherein the upper inner surface of the sludge space that extends to the at least one sludge outlet forms an upper sludge space angle β relative the axis of rotation (X) as seen in an axial plane;
wherein the upper inner surface of the sludge space extends radially at least half the radial distance from the at least one sludge outlet to the radial outer edge of the stack of separation discs, and wherein the upper sludge space angle β is more than 5 degrees but less than 15 degrees.

As seen in the axial plane, the sludge space tapers in the radial direction towards the sludge outlet and the upper inner surface of the centrifuge bowl extends from the sludge outlet and may thus form the axial upper portion of the sludge space.

In embodiments of the first aspect, the upper inner surface of the sludge space extends radially more than 80% of the distance from the at least one sludge outlet to the radial outer edge of the stack of separation discs.

In embodiments of the first aspect, the stack of separation discs is arranged below a top disc, and the upper inner surface of the sludge space extends radially all the way from the at least one sludge outlet to the radial outer edge of the top disc.

Such a top disc may delimit a channel for a separated liquid heavy phase that extends from the sludge space to a radial inner portion of the centrifuge bowl, such as to a heavy phase outlet chamber. The top disc may together with the inner wall of the centrifuge bowl delimit such a channel for a separated liquid heavy phase.

In embodiments of the first aspect, the upper inner surface of the sludge space extends radially all the way from the at least one sludge outlet to the radial outer edge of the stack of separation discs.

In embodiments of the first aspect, the upper inner surface of the sludge space has a straight cross-section without any change in direction, as seen in an axial plane. Thus, the upper inner surface may extend along only one direction as seen in an axial plane.

The first aspect of the invention is based on the insight that the upper sludge space angle β may impact the number of separation discs that may be fitted into the centrifugal separator. As an example, about 5-15% more separation discs may be fitted into the centrifuge bowl.

Upper sludge space angle β cannot be too small, since it impacts the ability of separated sludge to reach the solids outlet. In the prior art, the upper sludge space angle β is above 15 degrees. See for example prior art document U.S. Pat. No. 7,416,523, in which the angles of the tapering sections α1, α2, α3 are between 15° and 60°. Having an upper sludge space angle β of 15 degrees has more or less been the standard for centrifugal separators since it generally works well for all types of sludge. Thus, the inventors have realized that this angle may indeed be lower and that it at the same time permits more separation discs to be fitted within the bowl while still being able to handle sludge.

Thus, the present invention provides for a centrifugal separator having the same outer size as a previous bowl, but with a larger number of separation discs fitted inside and therefore a larger separation capacity. As demonstrated in the Experimental example, it has also been shown that a centrifuge bowl having such a small upper sludge space angle β may still is able to discharge separated sludge in a satisfactory way.

In embodiments of the first aspect, the upper sludge space angle β is between 11-14 degrees. As an example, the upper sludge space angle β may be about 13 degrees.

In embodiments of the first aspect, the upper sludge space angle β is more than 8 degrees but less than 15 degrees, such as between 10-14 degrees.

The centrifugal separator is for separation of a liquid feed mixture. The liquid feed mixture may be an aqueous liquid or an oily liquid. As an example, the centrifugal separator may be for separating solids and, potentially also another liquid, from the liquid feed mixture. The liquid mixture may for example be a dairy mixture, such as milk from which microbial cells are separated. The liquid mixture may also be other food products, such as beer, juice or other beverages.

The frame of the centrifugal separator is a non-rotating part, and the rotating part may be supported by the frame by at least one bearing device, which may comprise a ball bearing. The rotating part of the separator may be arranged to be rotated around vertical axis of rotation, i.e. the axis of rotation (X) may extend vertically. The rotating part comprises a centrifuge bowl. The centrifuge bowl is usually supported by a spindle, i.e. a rotating shaft, and may thus be mounted to rotate with the spindle. Consequently, the rotating part may comprise a spindle that is rotatable around the axis of rotation (X). The centrifugal separator may be arranged such that the centrifuge bowl is supported by the spindle at one of its ends, such at the bottom end or the top end of the spindle.

The drive member for rotating the rotating part of the separator may comprise an electrical motor having a rotor and a stator. The rotor may be fixedly connected to the rotating part, such as to a spindle. Advantageously, the rotor of the electrical motor may be provided on or fixed to the spindle of the rotating part. Alternatively, the drive member may be provided beside the spindle and rotate the rotating part by a suitable transmission, such as a belt or a gear transmission.

The centrifuge bowl encloses by rotor walls a separation space and a sludge space. The separation space, in which the separation of the fluid mixture takes place, comprises a stack of separation discs. The separation discs may e.g. be of metal. Further, the separation discs may be frustoconical separation discs, i.e. having separation surfaces forming frustoconical portions of the separation discs. The angle of inclination of the separation surface may be within the range of 30-50 degrees to the axis of rotation (X). Radially outside of the stack of separation discs is the sludge space, in which separated sludge and heavy phase is collected during operation. The sludge space thus extends radially from the outer portion of the stack of separation discs to the inner periphery of the centrifuge bowl.

The separation discs are arranged coaxially around the axis of rotation (X) at a distance from each other such that to form passages between each two adjacent separation discs. The separation discs in the disc stack may be arranged such that the liquid mixture to be separated flows radially inwards in the passages between each two adjacent separation discs of the stack.

As used herein, the term “axially” denotes a direction which is parallel to the rotational axis (X). Accordingly, relative terms such as “above”, “upper”, “top”, “below”, “lower”, and “bottom” refer to relative positions along the rotational axis (X). Correspondingly, the term “radially” denotes a direction extending radially from the rotational axis (X). A “radially inner position” thus refers to a position closer to the rotational axis (X) compared to “a radially outer position”.

The centrifugal separator also comprises an inlet for liquid mixture to be separated (the liquid feed mixture). This inlet may be arranged for receiving the liquid feed mixture and be arranged centrally in the centrifuge bowl, thus at rotational axis (X). The centrifugal separator may be arranged to be fed from the bottom, such as through a spindle, so that the liquid feed mixture is delivered to the inlet from the bottom of the separator.

The at least one liquid outlet may be arranged on an upper portion of the centrifuge bowl, such as axially above the stack of separation discs.

In embodiments of the first aspect, the lower inner surface of the sludge space that extends to the sludge outlet forms a lower sludge space angle γ relative the axis of rotation (X) as seen in an axial plane; and wherein the lower sludge space angle γ is 15 degrees or more.

Consequently, the lower sludge space angle γ may be larger than the upper sludge space angle β. It may be advantageous to have a lower sludge space angle γ at 15 degrees or more since it allows other parts of the centrifuge bowl to be as in prior art separators. An example of such a part is an operating slide that is used for opening and closing intermittently openable sludge outlets. Further, the inventors have found that decreasing the upper sludge space angle β may have a higher effect in fitting a larger number of separation discs in the bowl than the effect of the lower sludge space angle γ.

In embodiments of the first aspect, the separating surface of the separation discs in the stack forms an angle α with the axis of rotation (X) as seen in an axial plane; and wherein α is between 32-38 degrees, such as about 35 degrees.

Half of the opening angle of the frustoconical shape is usually defined as the a. An angle α with the axis of rotation (X) as seen in an axial plane between 32-38 degrees may be beneficial when fitting as many separation discs as possible in the disc stack when the upper sludge space angle β is less than 15 degrees.

In embodiments of the first aspect, the stack of separation discs comprises more than 200 separation discs.

For example, the stack of separation discs may have a diameter that is more than 300 mm and a thickness that is less than 0.40 mm, such as less than 0.30 mm.

As an example, all discs of the stack and or the set of separation discs may have the same diameter and/or thickness.

The liquid feed mixture may be separated into at least two liquid phases; a liquid light phase and a liquid heavy phase. Consequently, in embodiments of the first aspect, the at least one liquid outlet for a separated liquid phase comprises a first liquid outlet for the liquid heavy phase and a second liquid outlet for the liquid light phase.

The liquid heavy phase has a density that is higher than the density of the light phase. The centrifugal separator may thus be arranged to separate the liquid feed mixture into a liquid light phase, a liquid heavy phase and a solids phase, i.e. a sludge phase, and hence, the centrifugal separator may comprise a first liquid outlet for a heavy phase, a second liquid outlet for a light phase and sludge outlets for separated sludge.

In embodiments of the first aspect, the sludge outlet is in the form of a set of intermittently openable outlets.

The centrifuge bowl may therefore centrifuge comprise at its outer periphery a set of radially sludge outlets in the form of intermittently openable outlets. The intermittently openable outlets may be equidistantly spaced around the axis of rotation (X).

Moreover, the centrifugal separator may be free of any further annular chambers arranged radially outside the sludge space for concentrating the sludge. Thus, the centrifugal separator may be arranged such that separated sludge may be directly discharged via the sludge outlets from the sludge space.

As a second aspect of the invention, there is provided a method of separating a solids phase and at least one liquid phase from a liquid feed mixture, comprising the steps of
a) introducing the liquid feed mixture into a centrifugal separator (1) according to the first aspect of the invention,
b) discharging a separated solids phase from said centrifugal separator, and
c) discharging at least one separated liquid phase from said centrifugal separator.

This aspect may generally present the same or corresponding advantages as the former aspect. Effects and features of this second aspect are largely analogous to those described above in connection with the first aspect. Embodiments mentioned in relation to the first aspect are largely compatible with the second aspect.

In embodiments of the second aspect, step b) comprises intermittently ejecting the separated solids phase through a set of intermittently openable outlets.

The liquid feed mixture may be separated into at least two liquid phases; a liquid light phase and a liquid heavy phase. Consequently, in embodiments of the second aspect, the at least one separated liquid phase is a liquid light phase and a liquid heavy phase.

The inventive concept disclosed herein may be used when separating a variety of different feed mixtures.

As an example, the method and centrifugal separator may be used for bactofugation, which is the process of removing microorganisms, mainly spore formers, from milk using centrifugal force. Thus, in embodiments of the first aspect, the liquid feed mixture comprises microbial cells that are separated in said solids phase.

In embodiments of the first aspect, the liquid feed mixture is a beverage, such as a juice or beer. The liquid feed mixture may also be a liquid mixture in a biopharmaceutical process.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 shows a schematic drawing of a centrifugal separator according to an embodiment of the present invention.

FIG. 2 shows a schematic drawing of a cross-section of a centrifuge bowl.

FIG. 3 shows a schematic drawing of a cross-section of the sludge space of a centrifuge bowl.

FIG. 4 shows a flow chart of a method of separating a solids phase and at least one liquid phase from a liquid feed mixture.

### DETAILED DESCRIPTION

The centrifugal separator and the method according to the present disclosure will be further illustrated by the following description with reference to the accompanying drawings.

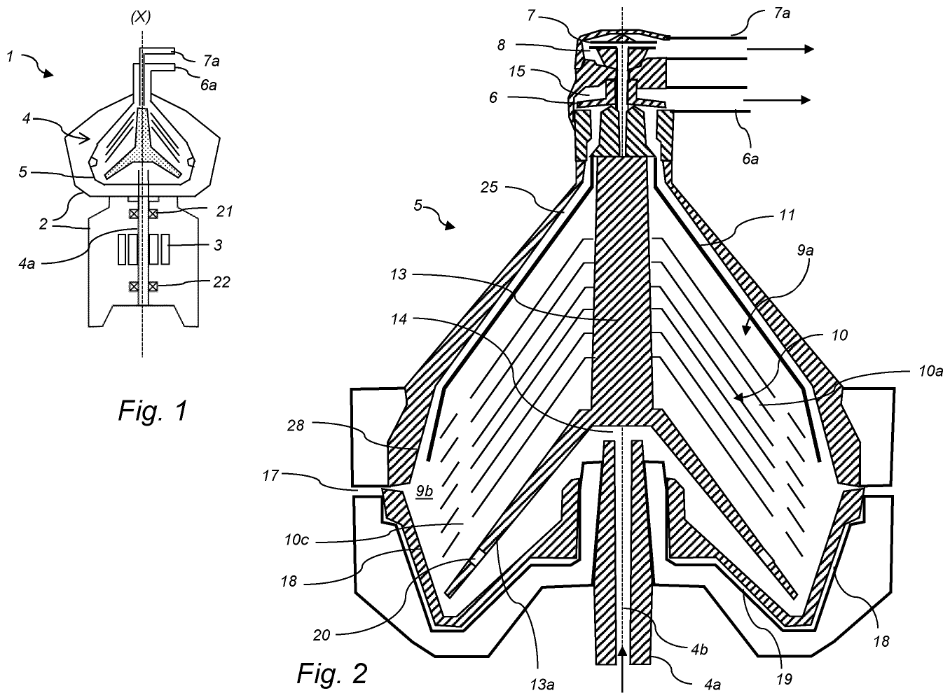

FIG. 1 show a cross-section of an embodiment of a centrifugal separator 1 configured to separate a heavy phase and a light phase from a liquid feed mixture. The centrifugal separator 1 has a rotating part 4, comprising the centrifuge bowl 5 and drive spindle 4a.

The centrifugal separator 1 is further provided with a drive motor 3. This motor 3 may for example comprise a stationary element and a rotatable element, which rotatable element surrounds and is connected to the spindle 4a such that it transmits driving torque to the spindle 4a and hence to the centrifuge bowl 5 during operation. The drive motor 3 may be an electric motor. Alternatively, the drive motor 3 may be connected to the spindle 4a by transmission means. The transmission means may be in the form of a worm gear which comprises a pinion and an element connected to the spindle 4a in order to receive driving torque. The transmission means may alternatively take the form of a propeller shaft, drive belts or the like, and the drive motor may alternatively be connected directly to the spindle 4a.

The centrifuge bowl 5, shown in more detail in FIG. 2, is supported by the spindle 4a, which is rotatably arranged in a frame 2 around the vertical axis of rotation (X) in a bottom bearing 22 and a top bearing 21. The stationary frame 2 surrounds centrifuge bowl 5.

In the centrifugal separator as shown in FIG. 1, liquid feed to be separated is fed from the bottom to the centrifuge bowl 5 via the drive spindle 4a. The drive spindle 4a is thus in this embodiment a hollow spindle, through which the feed is supplied to the centrifuge bowl 5. However, in other embodiments, the liquid feed mixture to be separated is supplied from the top, such as through a stationary inlet pipe extending into the centrifuge bowl 5.

After separation has taken place within the centrifuge bowl 5, separated liquid heavy phase is discharged through stationary outlet pipe 6a, whereas separated liquid light phase is discharged through stationary outlet pipe 7a.

FIG. 2. shows a more detailed view of the centrifuge bowl 5 of the centrifugal separator 1.

The centrifuge bowl 5 forms within itself a separation space 9a and a sludge space 9b, located radially outside the separation space 9a. In the separation space 9a, a stack 10 of separation discs 10a is arranged coaxially around the axis of rotation (X) and axially below a top disc 11 and is thus arranged to rotate together with the centrifuge bowl 5. The separation discs 10a provide for an efficient separation of the liquid mixture into at least a liquid light phase and a liquid heavy phase. Thus, in the separation space 9a centrifugal separation of e.g. a liquid feed mixture to takes place during operation.

The stack 10 is supported at its axially lowermost portion by distributor 13. The distributor 13 comprises an annular conical base portion 13a arranged to conduct liquid mixture from the center inlet 14 of the centrifuge bowl 5 to a predetermined radial level R1 in the separation space 9, and a central neck portion extending upwards from the base portion 13a.

The sludge space 9b is in this embodiment confined between an upper inner surface 28 of the centrifuge bowl 5 and an axially movable operating slide 18.

The centrifuge bowl 5 further comprises an inlet 14 in the form of a central inlet chamber formed within or under the distributor 13. The inlet is arranged for receiving the liquid feed mixture and is thus in fluid communication with the hollow interior 4b of the spindle 4a, through which the liquid feed is supplied to the centrifuge bowl 5.

The inlet 14 communicates with the separation space 9 via passages 20 formed in the base portion 13a of the distributor 13. The passages 20 may be arranged so that liquid mixture is transported to a radial level that corresponds to the radial level of the cut-outs 10c provided in the separation discs 10a. The cut-outs 10c form axial channels within the disc stack and distributes the liquid feed mixture throughput the disc stack 10.

The top disc 11 and an upper inner wall of the centrifuge bowl 5 delimits at least one channel 25 extending from the sludge space 9b towards a central portion of the centrifuge bowl 5. The first liquid outlet 6 is arranged in a first outlet chamber 15, which is in fluid communication with the at least one channel 25 for discharge of a separated liquid heavy phase.

The radially inner portion of the disc stack 10 communicates with a second outlet 7 for a separated light phase of the liquid feed mixture. The second outlet 7 is arranged in a second outlet chamber 8.

The centrifuge bowl 5 is further provided with outlets 17 at the radially outer periphery of the sludge space 9b. These outlets 17 are evenly distributed around the rotor axis (X) and are arranged for intermittent discharge of a sludge component of the liquid feed mixture. The sludge component comprises denser particles forming a sludge phase. The opening of the outlets 17 is controlled by means of an operating slide 18 actuated by operating water in channel 19, as known in the art. In its position shown in the drawing, the operating slide 18 abuts sealingly at its periphery against the upper part of the centrifuge bowl 5, thereby closing the sludge space 9b from connection with outlets 17, which are extending through the centrifuge bowl 5.

During operation of the separator as shown in FIGS. 1 and 2, the centrifuge bowl is brought into rotation by the drive motor 3. Via the spindle 4a, liquid feed mixture to be separated is brought into the separation space 9a. Depending on the density, different phases in the liquid feed mixture is separated between the separation discs of the stack 10. Heavier component, such as a liquid heavy phase and a sludge phase, move radially outwards between the separation discs 10a to the sludge space 9b, whereas the phase of lowest density, such as a liquid light phase, moves radially inwards between the separation discs 10a and is forced through second outlet 7 arranged in the second liquid outlet chamber 8. The liquid of higher density is instead forced out through the passages 25 over the top disc 11 to the liquid outlet 6 for the liquid heavy phase. Thus, during separation, an interphase between the liquid of lower density and the liquid of higher density is formed in the centrifuge bowl 5, such as radially within the stack of separation discs. Solids, or sludge, accumulate at the periphery of the sludge space 9b and is emptied intermittently from within the centrifuge bowl by the sludge outlets 17 being opened, whereupon sludge and a certain amount of fluid is discharged from the separation chamber 17 by means of centrifugal force. However, the discharge of sludge may also take place continuously, in which case the sludge outlets 17 take the form of open nozzles and a certain flow of sludge and/or heavy phase is discharged continuously by means of centrifugal force.

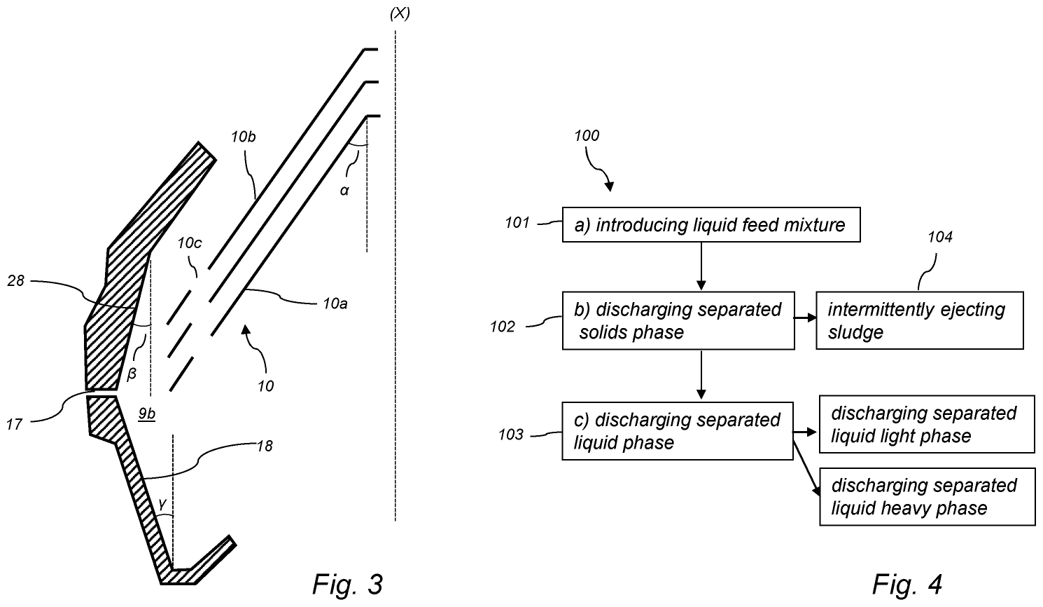

FIG. 3 shows a close-up view of the sludge space 9b of the centrifuge bowl 5. As seen in the axial plane, the sludge space 9b tapers in the radial direction towards the sludge outlet 17. The upper inner surface 28 of the sludge space 9b, i.e. the inner surface that extends to the sludge outlet 17, forms an upper sludge space angle β relative the axis of rotation (X) as seen in an axial plane. The upper inner surface 28 forms in this embodiment the axially upper portion of the sludge space 9b, i.e. it extends radially throughout the whole extension of the sludge space 9b.

This sludge space angle β is less than 15 degrees, such as more than 5 degrees but less than 15 degrees. In this embodiment, the upper sludge space angle β is about 13 degrees.

Further, the upper inner surface 28 of the sludge space 9b extends in this example radially all the way from the at least one sludge outlet 17 to the radial outer edge of the stack 10 of separation discs 10a. Due to the upper sludge space angle β being smaller than 15 degrees, a larger number of separation discs 10a may be fitted in the disc stack compared to prior art centrifugal separators, in which the upper sludge space angle β is 15 degrees or more.

A larger number of separation discs 10a provides for a higher separation capacity. Further, the inventors have found that having an upper sludge space angle β being between 11 and 15 degrees, such as about 13 degrees, still allows for sufficient transport of separated sludge radially outwards towards the sludge outlet.

As seen in FIG. 3, the sludge space is delimited also with a lower inner surface, which also tapers in the radial direction towards the sludge outlet 17. The lower inner surface is in this example formed by the operating slide 18 since the centrifugal separator 1 is arranged for intermittently discharging separated solids. However, in centrifugal separators arranged for continuous discharge, the lower inner surface of the sludge space could be a fixed lower inner surface of the centrifuge bowl 5. The lower inner surface of the sludge space 9b that extends to the sludge outlet 17 forms a lower sludge space angle γ relative the axis of rotation (X) as seen in an axial plane. In this example, the lower sludge space angle γ is 15 degrees or more, which means that a traditional operating slide 18 may be used.

Also shown in FIG. 3 is the angle α of the frustoconical separation discs relative the axis of rotation (X). The separating surface 10b, i.e. the conical surface of the frustoconical separation discs 10a, forms an angle α with the axis of rotation (X) as seen in an axial plane that is between 32-38 degrees, such as about 35 degrees. FIG. 4 illustrates a method 100 of separating a solids phase and at least one liquid phase from a liquid feed mixture. The method 100 comprises the steps of

a) introducing 101 the liquid feed mixture into a centrifugal separator 1. This separator may thus be a centrifugal separator as disclosed herein above, such as the centrifugal separator discussed in relation to FIGS. 1-3.

The method 100 further comprises a step b) of discharging 102 a separated solids phase from said centrifugal separator and a step c) of discharging 103 at least one separated liquid phase from said centrifugal separator 1.

As illustrated in the flow chart of FIG. 4, step b) may comprise intermittently ejecting 104 the separated solids phase through a set of intermittently openable outlets. Further, the at least one separated liquid phase may be a liquid light phase and a liquid heavy phase. Thus, the method 100 may comprise the steps of discharging a liquid heavy phase and discharging a liquid light phase.

The liquid feed mixture may for example be milk and may comprise microbial cells that are separated in said solids phase. However, the method may also be used in a variety of other applications, such as in the separation of different dairy applications, citrus juice, and in the production of beverages, such as beer.

### Experimental Example

A centrifugal separator Bactofuge type BB55 Eco (TetraPak) was rebuilt to have an upper sludge space angle of 13 degrees. Therefore, also a number of extra discs could be used. Inspection of the bowl interior was performed after 3 production runs and a cleaning-in-place-operation, and also after 2 weeks of production. The liquid feed mixture was milk from which microbes was separated as the sludge phase.

Both after the initial production run as well as after 2 weeks of production, both the disc stack and the interior of the centrifuge bowl were clean.

This experimental example thus demonstrates that having an upper sludge space angle of 13 degrees both allows for more discs to be fitted into the separator and also provides for excellent sludge discharge without sludge deposition on the interior walls of the centrifuge bowl or within the disc stack.

The invention is not limited to the embodiment disclosed but may be varied and modified within the scope of the claims set out below. The invention is not limited to the orientation of the axis of rotation (X) disclosed in the figures. The term “centrifugal separator” also comprises centrifugal separators with a substantially horizontally oriented axis of rotation. In the above the inventive concept has mainly been described with reference to a limited number of examples. However, as is readily appreciated by a person skilled in the art, other examples than the ones disclosed above are equally possible within the scope of the inventive concept, as defined by the appended claims.

1. A centrifugal separator for separating at least one liquid phase and a solids phase from a liquid feed mixture, comprising:
a frame;
a drive member; and
a rotating part,
wherein the drive member is configured to rotate the rotating part in relation to the frame around an axis of rotation,
wherein the rotating part comprises a centrifuge bowl enclosing a separation space and a sludge space,
wherein the separation space comprises a stack of separation discs arranged coaxially around the axis of rotation and wherein said sludge space is arranged radially outside said stack of separation discs,
wherein the centrifuge bowl further comprises an inlet for receiving the liquid feed mixture, at least one liquid outlet for a separated liquid phase, and at least one sludge outlet for a separated solids phase arranged at a periphery of the centrifuge bowl,
wherein an upper inner surface of the sludge space that extends to the at least one sludge outlet forms an upper sludge space angle β relative the axis of rotation as seen in an axial plane,
wherein the upper inner surface of the sludge space extends radially at least half a radial distance from the at least one sludge outlet to a radial outer edge of the stack of separation discs, and
wherein the upper sludge space angle β is more than 5 degrees but less than 15 degrees.

2. The centrifugal separator according to claim 1, wherein the upper sludge space angle β is between 11-14 degrees.

3. The centrifugal separator according to claim 2, wherein the upper sludge space angle β is about 13 degrees.

4. The centrifugal separator according to claim 1, wherein the upper inner surface of the sludge space extends radially all the way from the at least one sludge outlet to a radial outer edge of the stack of separation discs.

5. The centrifugal separator according to claim 1, wherein the upper inner surface of the sludge space has a straight cross-section without any change in direction, as seen in an axial plane.

6. The centrifugal separator according to claim 1, wherein a lower inner surface of the sludge space that extends to the sludge outlet forms a lower sludge space angle γ relative the axis of rotation as seen in an axial planet plane, and wherein the lower sludge space angle γ is 15 degrees or more.

7. The centrifugal separator according to claim 1, wherein the separating surface of the separation discs in the stack of separation discs forms an angle α with the axis of rotation as seen in an axial plane, and wherein the angle α is between 32-38 degrees.

8. The centrifugal separator according to claim 1, wherein the stack of separation discs comprises more than 200 separation discs.

9. The centrifugal separator according to claim 1, wherein the at least one liquid outlet for a separated liquid phase comprises a first liquid outlet for a liquid heavy phase and a second liquid outlet for a liquid light phase.

10. The centrifugal separator according to claim 1, wherein the sludge outlet is in the form of a set of intermittently openable outlets.

11. A method of separating a solids phase and at least one liquid phase from a liquid feed mixture, comprising the steps of:
a) introducing the liquid feed mixture into the centrifugal separator according to claim 1;
b) discharging a separated solids phase from said centrifugal separator; and
c) discharging at least one separated liquid phase from said centrifugal separator.

12. The method according to claim 11, wherein step b) comprises intermittently ejecting the separated solids phase through a set of intermittently openable outlets.

13. The method according to claim 11, wherein the at least one separated liquid phase is a liquid light phase and a liquid heavy phase.

14. The method according to claim 11, wherein the liquid feed mixture comprises microbial cells that are separated in said solids phase.

15. The centrifugal separator according to claim 1, wherein the separating surface of the separation discs in the stack of separation discs forms an angle α with the axis of rotation as seen in an axial plane, and wherein the angle α is about 35 degrees.

16. The centrifugal separator according to claim 2, wherein the upper inner surface of the sludge space extends radially all the way from the at least one sludge outlet to a radial outer edge of the stack of separation discs.

17. The centrifugal separator according to claim 3, wherein the upper inner surface of the sludge space extends radially all the way from the at least one sludge outlet to a radial outer edge of the stack of separation discs.

18. The centrifugal separator according to claim 2, wherein the upper inner surface of the sludge space has a straight cross-section without any change in direction, as seen in an axial plane.

19. The centrifugal separator according to claim 3, wherein the upper inner surface of the sludge space has a straight cross-section without any change in direction, as seen in an axial plane.

20. The centrifugal separator according to claim 4, wherein the upper inner surface of the sludge space has a straight cross-section without any change in direction, as seen in an axial plane.
